(19) United States
(12) Patent Application Publication
(10) Pub. No.: US 2011/0252117 A1
(43) Pub. Date: Oct. 13, 2011

(54) Devices and Methods for Redirecting a Browser to Access Computer Resource Behind a Network Firewall

(76) Inventors: SWEE HUAT SNG, Torrance, CA (US); Lena Sojian, Fountain Valley, CA (US)

(21) Appl. No.: 12/758,705

(22) Filed: Apr. 12, 2010

(51) Int. Cl. G06F 15/16

(52) U.S. Cl. 709/219

(57) ABSTRACT

Webpage-based redirection, from an application of a device external to a local device behind a network firewall, is accomplished via Hypertext Markup Language Protocol (HTTP) to invoke local instructions, e.g., script, to computer resources at the local device, such as computer resources at a multifunction peripheral (MFP) device behind the network firewall. HTTP-based communication of the results of execution of the invoked local instruction is made to the external application.

### TECHNICAL FIELD

Embodiments pertain to systems and devices for, and methods of, accessing a computing device hosting a computer resource, disposed behind a network firewall, by an application executed external to the firewall.

### BACKGROUND

FIG. 1A depicts the two-way communication between the nodes of a computer network. A local node or local computing device 110 may host a protocol service endpoint allowing externally-hosted applications, such as an application server of a remote device 120 to invoke imaging and/or other service functions. The exemplary computing device 110 may start the execution of the application by having an embedded web browser connect to the application of the application server 120, thereby establishing a User Interface (UI) Channel 130. A user 131 at the computing device 110 may interact with the remote application via the UI Channel 130. When imaging functions are requested by the user 131, the application may initiate a protocol method call to the computing device 110. The method call initiated by the application is termed the Command Channel 140. Accordingly, the remote application at the application server 120 may control the computing device 110 via the Command Channel 140.

An architecture embodying the UI Channel 130 and the Command Channel 140 is operable when the nodes, i.e., the computing device 110 and application server 120, can connect to each other directly. FIG. 1B depicts a breakdown in the two-way communication between the nodes. The two-way communication is illustrated as breaking down when network access is asymmetric; i.e., when only one node can initiate a connection to the other. This is the case when the computing device 110 is deployed within a network environment where the computing device 110 is ostensibly protected by a network firewall 150. An external, publicly-accessible, application server 120 can be contacted by the computing device 110, since network connections initiated within a firewall are allowed to pass through—so, the UI Channel 130 works properly. However, the application on the application server 120 can no longer connect to the computing device 110 through the Command Channel 140, since the network connection attempt is now blocked by the firewall 150.

Access to a computing device 110 by an application server 120 may be accomplished via a virtual private network (VPN) connection between the application and the network within which the target resource resides. The implementation of a VPN opens up a virtual direct connection, i.e., a tunnel, between the application of the application server and computing device 110, and allows the UI Channel and Command Channel to provide two-way communication between the nodes. The VPN typically requires additional components, and network configuration modifications to an existing network. A VPN may also compromise the security of other devices on the network by inadvertently granting, to an otherwise unauthorized external entity, unfettered access to devices behind the firewall.

### SUMMARY

Access, by an application executed, for example, by a computing device such as an application server device, to a local device such as multifunction peripheral (MFP) device, disposed behind a firewall relative to the application, may be accomplished via the methods, devices, system configurations, and components described herein. A computing resource is defined as: a component in a computing environment that provides useful data or service. Examples of a computing resource include, but are not limited to: a web service, a hardware device, a database, a dynamic script, a static file, and an Input/Output (I/O) port. A method embodiment for accessing a computing resource behind a network firewall by an application outside the firewall may comprise: (a) fetching, by a web browser of a local computing device, a page of an application from a source external to the local computing device; (b) receiving, by the web browser, the page of the application comprising a redirection instruction to a script file stored at the local computing device as a destination page; (c) redirecting, by the web browser, to the script file as the destination page, wherein the script file comprises a call instruction, e.g., a Simple Object Access Protocol (SOAP) call instruction; (d) invoking an call instruction based on the script file call instruction, e.g., a SOAP call instruction; (e) generating a result based on a response by the local computing device to the invoked call; and (f) submitting the generated result to a Uniform Resource Locator (URL) endpoint of an application hosted at the source external to the local computing device. The browser may be a Hypertext Transfer Protocol (HTTP) browser client on the local computing device, and the external source may be a remote host. The browser fetching may include initiating an outgoing HTTP connection to a remote server of the remote host. The page received by the browser may include an HTTP payload from the remote host comprising an instruction to redirect the browser to an internally-hosted script of the local computing device. The submitting of the generated result to the external host may be via at least one of: HTTP GET and HTTP POST.

An exemplary device embodiment includes a computing device behind a network firewall comprising: a processor and addressable memory comprising a computer resource and a script file comprising a call instruction, e.g., a Simple Object Access Protocol (SOAP) call instruction, wherein the processor is configured to: (a) fetch, by a web browser, a page of an application from a source external to the device and the network firewall; (b) receive, by the browser, the page of the application comprising a redirection instruction to the stored script file as a destination page; (c) redirect, by the browser, to the script file as the destination page; (d) invoke a call, e.g., a SOAP call based on the script file call instruction, e.g., the SOAP call instruction; (e) generate a result based on a response by the processor to the invoked call, e.g., the invoked SOAP call; and (f) submit the generated result to a Uniform Resource Locator (URL) endpoint of an application hosted at the source external to the local computing device.

For example, computer resources may be hosted on a local device behind a network firewall from a remote host. A Hypertext Transfer Protocol (HTTP) browser client on a local device residing within the firewall may initiate outgoing HTTP connections to the remote server. Embodiments include the local device initiating an HTTP connection to the remote host. The remote host may then respond with an HTTP payload that redirects to an internally-hosted script of the local device. The local device may then generate a result by executing steps according to the script, and the local device may then send the result of the executed script directly to the remote host, e.g., via either HTTP GET or HTTP POST.

### BRIEF DESCRIPTION OF THE DRAWINGS

Embodiments are illustrated by way of example and not limitation in the figures of the accompanying drawings, and in which:

FIG. 1A depicts in a top-level functional block diagram a prior art two-way communication between a multifunction peripheral device and a server;

FIG. 1B depicts in a top-level functional block diagram a prior art communication between a multifunction peripheral device and a server precluded by a network firewall;

FIG. 2 illustrates a top level functional block diagram of an exemplary multi-functional peripheral device;

FIG. 3 depicts in a top-level functional block diagram an embodiment of the two-way communication established via an HTTP-based redirect process;

FIG. 4 is a flowchart of an exemplary process;

FIG. 5 depicts in a top-level functional block diagram an embodiment of the two-way communication established via an HTTP redirect process; and

FIG. 6 illustrates an exemplary top level functional block diagram of a computing device embodiment of the present invention.

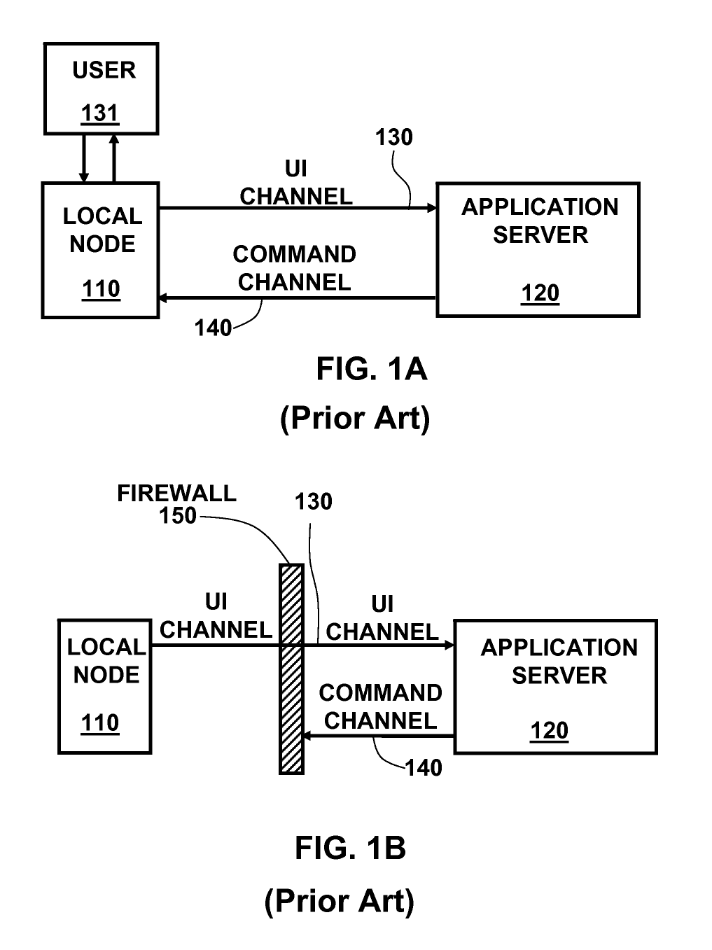

### DETAILED DESCRIPTION

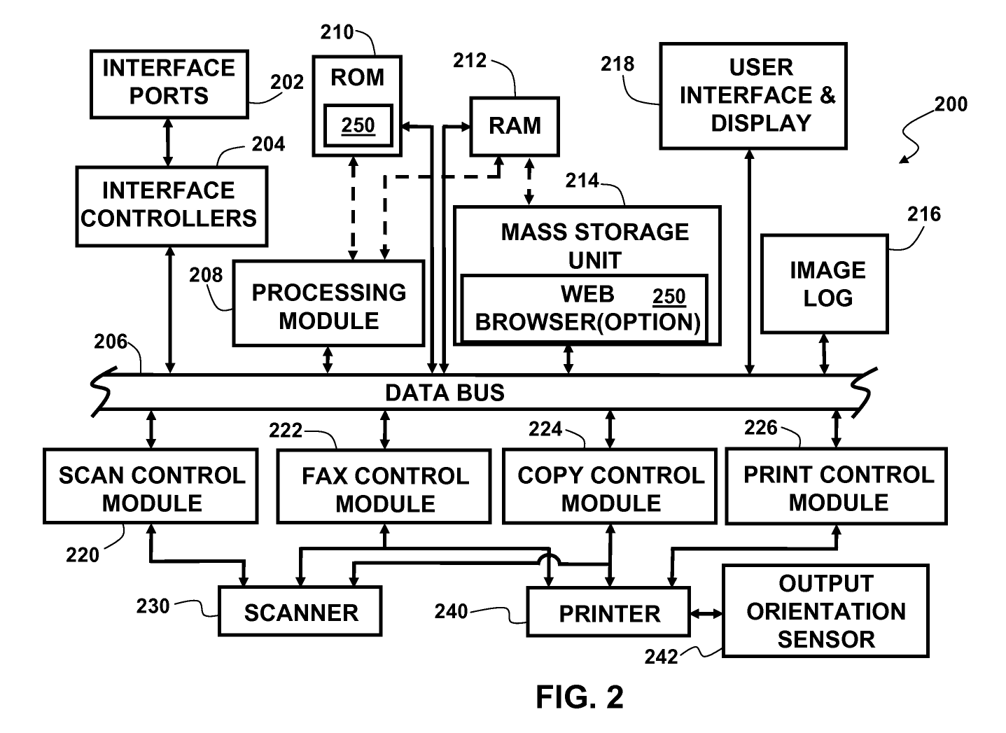

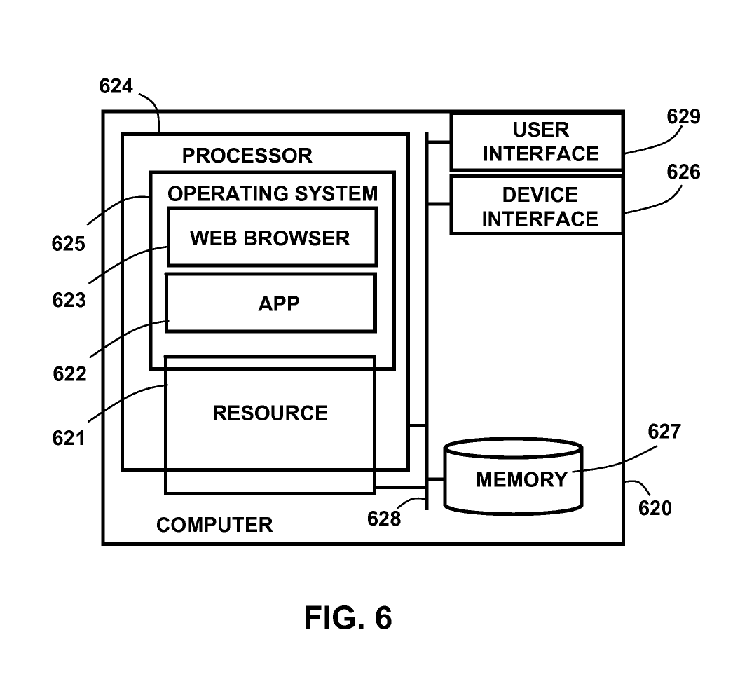

An exemplary multifunction peripheral (MFP) device may be illustrated in greater exemplary functional detail in FIG. 2. Interface ports 202 may be present to connect a printer cable, a network link, or an external wireless module. The interface ports 202 may be serviced by one or more interface controllers 204 that function to direct communications and/or condition signals between the respective interface port 202 and one or more modules of the MFP device 200 which may be in common communication via a data bus 206. The MFP device 200 may include one or more processing modules 208 that may draw data from read-only memory (ROM) 210 and exchange data with random access memory (RAM) 212 and may store files having sizes greater than the RAM 212 capacity in one or more mass storage units 214. The MFP device 200 may maintain a log of its images 216 and have a user display and interface 218. The image log 216 may be a separate module or distributed, for example, with a portion executed via the processing module 208 that may access parameters, files, and/or indices that may be stored in ROM 210, RAM 212, a mass storage unit 214 or in combination thereof. The MFP device includes a web browser component 250 that may initially be located in the ROM 210, and in some options of MFP devices, and other computing devices (and the exemplary computing node of FIG. 6), the web browser component 250 may initially be located in the mass storage unit 214 and loaded into RAM 212. For either exemplary initial means of storage, the web browser component 250 may be executed via the one or more processing modules 208, thereby providing a user interface as part of the user interface and display 218 features of the device 200. The MFP device 200 may include as individual or separate modules a scan control module 220, a facsimile (FAX) control module 222, and a copy control module 224, where each module may service the scanner 230 to direct communications and/or conditions signals between the scanner 230 and one or more modules of the MFP device 200, for example, via the data bus 206. The MFP device 200 may include as individual or separate modules the FAX control module 222, the copy control module 224, and a print control module 226 where each module may service the printer 240 to direct communications and/or condition signals between the printer 240 and the one or more modules of the MFP device 200, for example, via the data bus 206. The exemplary MFP device 200 may store a calibration table in ROM 210, RAM 212, a mass storage unit 214 or in combination thereof and accordingly, the calibration table may be accessed by the print control module 226 and/or a processing module 208 and made available to devices external to the MFP device 200 via one or more interface ports 202. The exemplary MFP device 200 may have notice, for example, due to a user input via the user interface 218 or sensed by an output orientation sensor 242 of the printer 240 and may be communicated via the print control module 226 to devices external to the MFP device 200 via one or more interface ports 202.

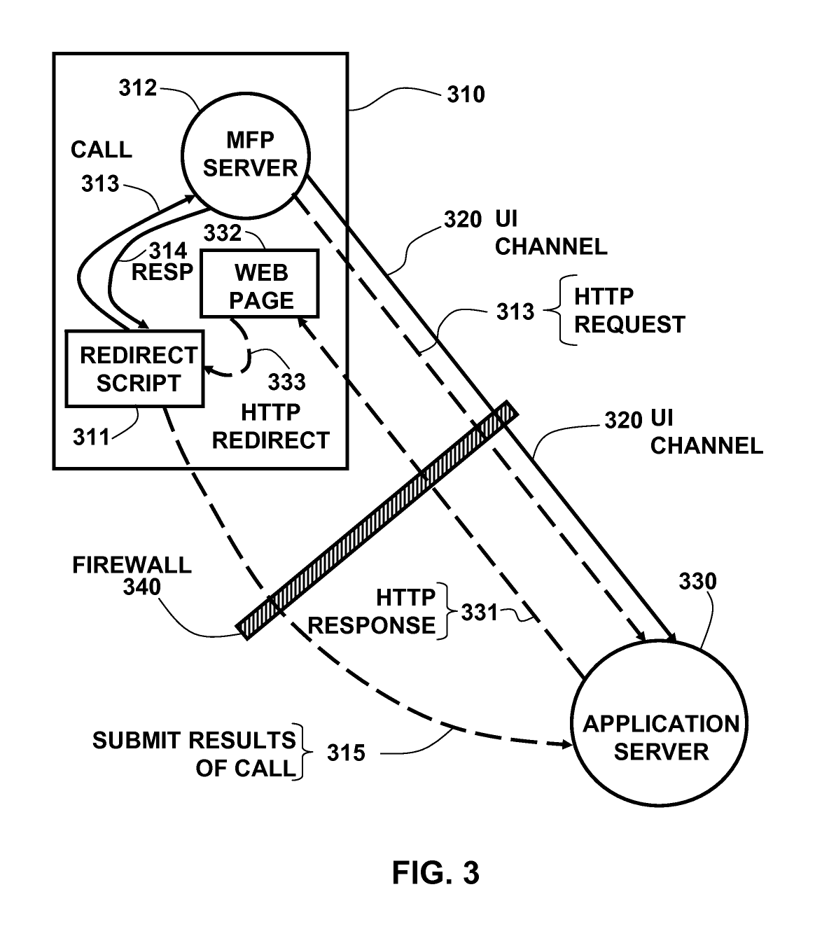

Reference is made to FIG. 3 illustrating an exemplary embodiment of the present invention. A local node, e.g., an MFP device 310, comprises an application server configured to execute server-side scripts and a web browser. An exemplary embodiment includes hosting a REDIRECT server-side script 311 residing locally on the MFP where an application server 312 on the MFP device 310 that may be configured to execute server-side scripts. Through the UI Channel 320, the MFP web browser may fetch one or more web pages from the remote application server 330, e.g., via an HTTP request 313. Due to the network firewall 340, the application of the application server 330 does not communicate via a Command Channel. The application may invoke operations on the MFP device 310 by making use of the UI Channel 320. The application does this by returning to the MFP device 310, e.g., in an HTTP response 331, a web page 332 that comprises in this example HTTP redirect logic, or redirection instructions. Exemplary embodiments of the HTTP redirect logic include: (a) HTTP redirect response, e.g., response code “3xx”; (b) Hypertext Markup Language (HTML) refresh meta tag; and (c) via form submission—either manually, e.g., via a submit button, or automatically, e.g., via JavaScript™; (d) via JavaScript™, e.g., via “location.href”; (e) JavaScript™ inside a hidden iframe; and (f) JavaScript™ Object Notification with padding (JSONP).

The HTTP redirect 333 may be targeted to the REDIRECT server-side script Uniform Resource Locator (URL) of the MFP device 310, and the HTTP redirect 333 may also pass in arguments, via either in the HTTP query string or a POST body, that specify the process instruction, and associated parameters, that are to be invoked, and may further specify the URL to which the results are to be sent. Accordingly, the server-side scripting environment executes the REDIRECT server-side script 311. The REDIRECT script processes the arguments passed in, and does so in order to determine which process instruction to call locally on the MFP device. The REDIRECT script 311 causes the MFP device processing to make the local SOAP call 313, and, via the response 314, to obtain the MFP device processing results of the SOAP call 313. The REDIRECT script 311 then causes MFP device processing to compose a web page to return to the web browser with new HTTP redirect logic embedded. The web browser then redirects the results 315 of the call from the REDIRECT script back to the remote application of the application server 330. The application in this example is thus configured to invoke methods on the MFP device absent a separate Command Channel.

The steps of an exemplary system operation may be characterized as follows: The web browser on local device, such as an MFP device, fetches via HTTP GET request the first page of the application from an application engine of the application server. The application engine of the application server returns the web page data to the web browser of the local device via HTTP GET response where the returned web page includes HTTP-based redirection. Responsive to the HTTP-based redirection, e.g., HTTP GET or HTTP POST of the returned web page, the browser of the local device executes a redirection to the destination page according to the redirection where the redirect destination is a script file. The application server of the local device loads and executes the script-based instructions of the script file to which the browser was directed, where the execution of the script instruction includes invoking an SOAP call to the MFP. The local device, e.g., the MFP device, responds to the SOAP call. The execution of the steps of the script file include: processing the SOAP response from the MFP, e.g., filtering the SOAP response to only include elements pertinent to the application, and submitting results to a URL endpoint on the application hosted at the remote device. For example, the application may invoke a call, such as a SOAP call, to get a job log containing all completed jobs. The instructions may be particularized to specific types of jobs, e.g., one or more print jobs, scan jobs, and/or jobs that failed to complete successfully. The script may include instructions to filter the response and only return the relevant ones needed by the application. The browser of the local device may display HTML elements, returned by execution of the steps of script file, in the HTTP response. The HTTP response from the script could be an HTTP redirect to the next page of the application hosted on the application server 330. This allows the application to progress to the next step after the invocation is completed.

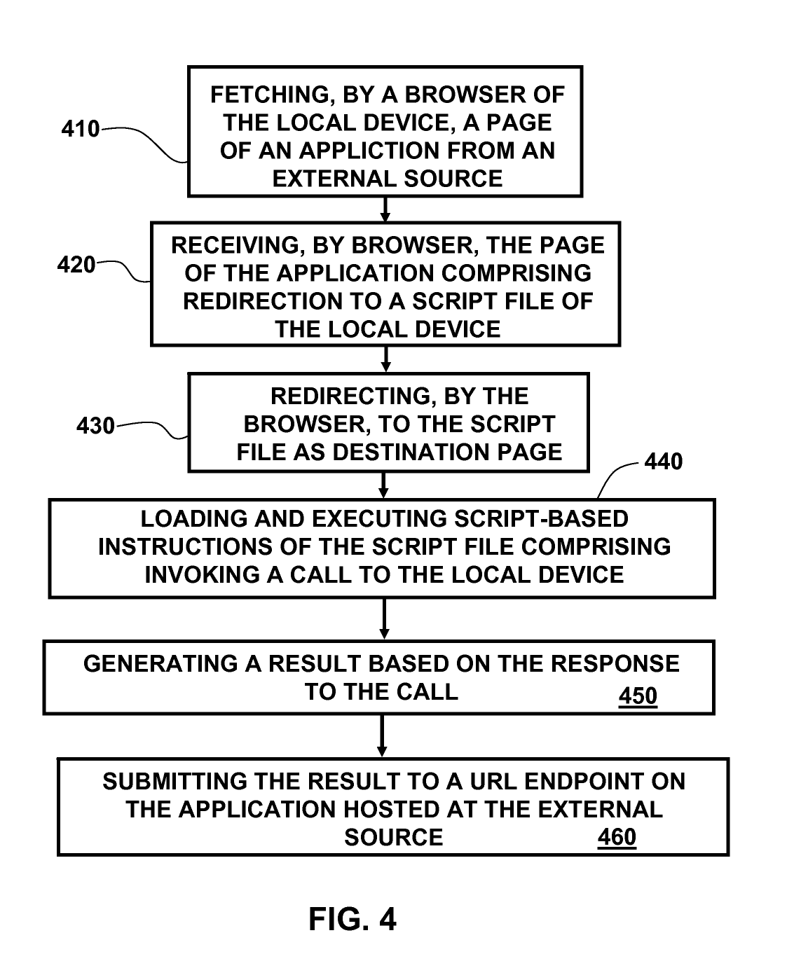

The local device, e.g., an MFP device behind the network firewall, comprises a computer and/or computing circuitry that may be configured to execute the steps as depicted in FIG. 4. The method depicted in the flowchart includes the steps of: (a) fetching, by the browser, a page of an application from an external source (step 410); (b) receiving, by the browser, the page of the application comprising browser redirection to a script file hosted on the local device (step 420); (c) redirecting, by the browser, to the script file as a destination page (step 430); (d) loading and executing script-based instruction of the script file where the instructions comprise invoking an SOAP call to the local device (step 440); (e) generating a result based on the response to the SOAP call (step 450); and (f) submitting the result to a URL endpoint on the application hosted at the external source (step 460).

Embodiments allow externally-hosted applications to access functions on an MFP device that is protected by a firewall. Embodiments may be implemented in embedded to allow external applications that are hosted on Internet Cloud servers to perform functions on a local device, such as a Sharp™ MFP device. An embedded infrastructure embodiment may be implemented that makes use of a web scripting framework (Appweb™), embedded web browser (NetFront™), and cloud application server (Google™ App Engine). Appweb™ is a standards-based embedded web server with built-in server-side scripting engine. Appweb™ supports EJSscript (Embedded JavaScript™), an Ecma International scripting language suitable for embedded web server applications. NetFront™ is an embedded web browser that is deployed in current Sharp™ MFP devices. Google™ App Engine is a cloud application framework that allows web applications to be deployed on servers of Google™. Legacy Open Sytems Architecture (OSA) applications are applications that are hosted on dedicated servers inside a corporate network. These applications can directly access (through the Command Channel) OSA resources on present Sharp™ MFPs within the same corporate network. Non-legacy OSA applications are applications that are hosted on public internet servers, such as Google™ App Engine. These applications have no way to access OSA resources on present Sharp™ MFPs that are protected by firewalls. Embodiments described herein allow non-legacy OSA applications to access OSA resources on any Sharp™ MFPs, even those that are protected by firewalls. Accordingly, a new generation of OSA applications utilizing HTTP redirect scheme allows these applications to access OSA resources on Sharp™ MFP devices that are previously only available to legacy OSA applications.

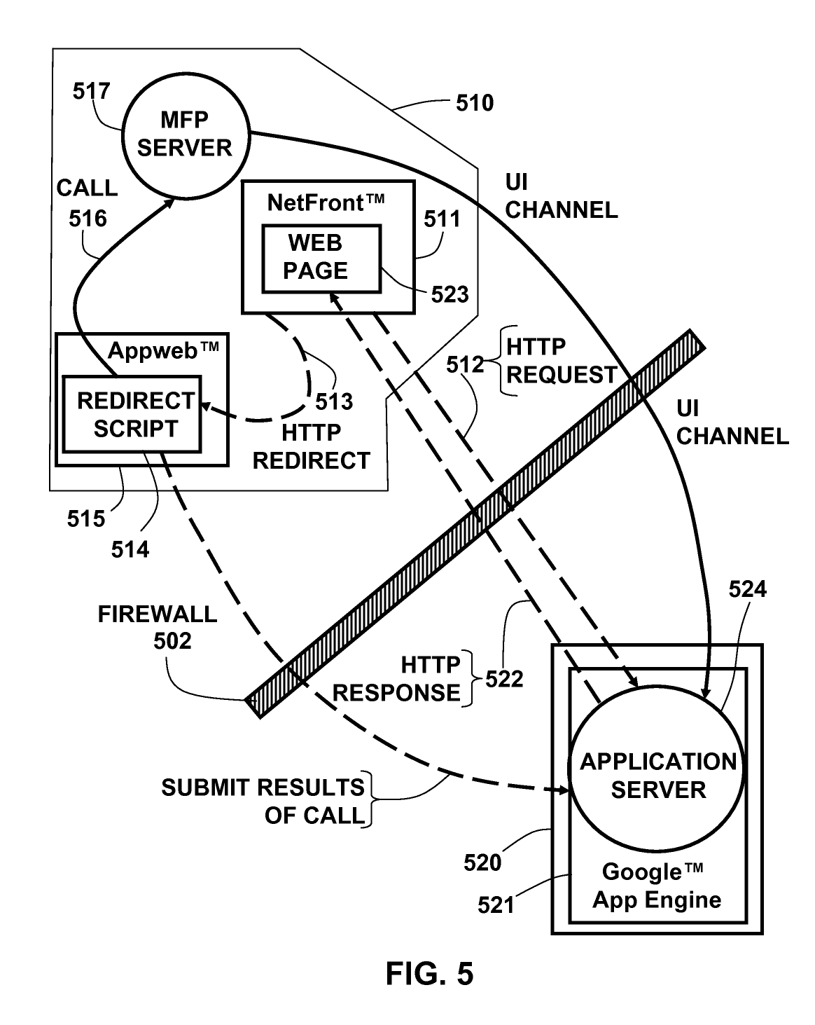

FIG. 5 depicts a top-level functional block diagram of the two-way communication, between two nodes across a network firewall 502, established via the HTTP redirect scheme using three exemplary components, namely Appweb™, NetFront™, and the Google™ App Engine. The steps of an exemplary operation may be characterized with reference to FIG. 5 as follows: A NetFront™ web browser 511 on a Sharp™ MFP device 510 fetches, e.g., via an HTTP GET request 512, the first page of the OSA application from Google™ App Engine 521 of a remote device 520. The Google™ App Engine 521 returns the web page data 523 to the NetFront™ web browser via an HTTP GET response 522, where the web page 523 includes HTTP redirect instructions, e.g., HTTP GET or HTTP POST. Responsive to the HTTP redirect instruction, the web browser 511 on the MFP device 510 redirects 513 to the destination page, i.e., the redirect script 514, e.g., to “Delegator.ejs.” The web browser 511 performs either an HTTP GET or HTTP POST, depending on the redirect format used in the HTTP response 522, to execute the redirect to the redirect script—redirect script may be a file termed “Delegator.ejs.” The Appweb™ server 515 loads and executes EJScript code inside Delegator.ejs script file 514. The Delegator.ejs script file invokes a custom EJScript method to invoke OSA SOAP call 516 to the MFP server 517 of the MFP device 510. An exemplary script file is provided as a computer program listing in the Appendix below. The MFP processor executes instructions of the Delegator.ejs script file based on the OSA SOAP response from the server of the MFP device to generate a result, and the generated result is submitted to a URL endpoint on the OSA application, hosted by the Google™ App Engine 521 at the remote device 520. The web browser 511 displays HTML elements returned by Delegator.ejs in the HTTP response, where the HTTP response may either be static HTML data or an HTTP redirect back to a web page on the OSA application 524 hosted by Google App Engine 521 at the remote device 520. If redirect back to the OSA application is invoked, control is again handed back to the OSA application at the remote device 520. Accordingly, the application, e.g., the OSA application, can then determine which web page to return next depending on the OSA call results it received in a previous step.

It is contemplated that while the three exemplary components above, namely Appweb™, NetFront™, and Google™ App Engine, may be used in embodiments of the embedded OSA, these are not the only available components required to practice embodiments. For example, any web server capable of server-side scripting support, e.g. Apache™, can be used in lieu of Appweb™, any web browser capable of standard HTTP redirect methods, e.g., Opera™ can be used in lieu of NetFront™, and any web application server environment capable of executing web applications, e.g., Microsoft™ Azure™ can be used in lieu of Google™ App Engine.

The redirect methods to access a computer resource behind a network firewall may be executed via the MFP device processing or may be executed at a separate computing node supporting SOAP calls from behind the network firewall. FIG. 6 depicts a separate computing node as an alternative exemplary operating environment for the redirect processing. The exemplary operating environment is shown as a computing device 620 comprising a processor 624, such as a central processing unit (CPU), addressable memory 627, an external device interface 626, e.g., an optional universal serial bus (USB) port and related processing, and/or an Ethernet port and related processing, and an optional user interface 629, e.g., an array of status lights and one or more toggle switches, and/or a display, and/or keyboard and/or pointer-mouse system and/or a touch screen. These elements may be in communication with one another via a data bus 628. Via an operating system 625 such as one supporting a web browser 623 and applications 622, the processor 624 may be configured to execute steps of a redirect method to access a computer resource 621 according to the exemplary embodiments described above.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

APPENDIX

```
COMPUTER PROGRAM LISTING
// This listing is exemplary computer code as a script file that invokes
the custom
// EJScript function
App.OsaScanAsync( ):
//Wrapper function for calling OsaScanAsyc
function scanAsync(eventData:Object):String{
  var jobId:String = undefined;
  //Get default settings from MFP and set them to values received from
  the calling form
  var settingNames:Array = “Common”::getSettingNamesEx(“SCAN”,
“Common”::getMfpCoreWsURL(params[‘remoteMfpUrl’]));
  var parameters:Object = buildParams(settingNames);
  //load these params value to session, for use later when we monitor the
  status in a new
    //thread.
  session[‘remoteMfpUrl’] = params[‘remoteMfpUrl’];
  session[‘appWebServerUrl’] = params[‘appWebServerUrl’];
  //Insert event params into params.
  for(var e:String in eventData) {
    parameters[e] = eventData[e];
  }
  var sessionId:String = getUiSessionId( );
  //Call OsaScanAsyc with the UISessionId and the parameters array
  jobId =
App.OsaScanAsync(“Common”::getMfpCoreWsURL(params
[‘remoteMfpUrl’]), sessionId, parameters);
  return jobId;
}
```

What is claimed is:

1. A method comprising:
fetching, by a web browser of a local computing device, a page of an application from a source external to the local computing device;
receiving, by the web browser, the page of the application comprising a redirection instruction to a script file stored at the local computing device as a destination page;
redirecting, by the web browser, to the script file as the destination page, wherein the script file comprises a call instruction;
invoking a call based on the script file call instruction;
generating a result based on a response by the local computing device to the invoked call; and
submitting the generated result to a Uniform Resource Locator (URL) endpoint of the application hosted at the source external to the local computing device.

2. The method of claim 1 wherein the call instruction is a Simple Object Access Protocol (SOAP) call instruction.

3. The method of claim 1 wherein the browser is a Hypertext Transfer Protocol (HTTP) browser client on the local computing device

4. The method of claim 3 wherein the external source is a remote host.

5. The method of claim 4 wherein the browser fetching comprises initiating an outgoing HTTP connection to a remote server of the remote host.

6. The method of claim 4 wherein the page received by the browser comprises an HTTP payload from the remote host comprising an instruction to redirect the browser to an internally-hosted script of the local computing device.

7. The method of claim 4 wherein submitting the generated result is via at least one of: HTTP GET and HTTP POST.

8. A computing device comprising:
a processor and addressable memory comprising a computer resource and a script file comprising a call instruction, wherein the processor is configured to:
fetch, by a web browser, a page of an application from a source external to the device;
receive, by the browser, the page of the application comprising a redirection instruction to the stored script file as a destination page;
redirect, by the browser, to the script file as the destination page;
invoke a call based on the script file call instruction;
generate a result based on a response by the processor to the invoked call; and
submit the generated result to a Uniform Resource Locator (URL) endpoint of the application hosted at the source external to the local computing device.

9. The computing device of claim 8 wherein the call instruction is Simple Object Access Protocol (SOAP) call instruction.

10. The computing device of claim 8 wherein the browser is a Hypertext Transfer Protocol (HTTP) browser client on the local computing device.

11. The computing device of claim 10 wherein the external source is a remote host.

12. The computing device of claim 11 wherein the processor is further configured to fetch by the web browser via an outgoing HTTP connection to a remote server of the remote host.

13. The computing device of claim 11 wherein the page received by the browser comprises an HTTP payload from the remote host comprising an instruction to redirect the browser to an internally-hosted script of the local computing device.

14. The computing device of claim 11 wherein the processor is further configured to submit the generated result via at least one of: HTTP GET and HTTP POST.
